(19) United States
(12) Patent Application Publication
(10) Pub. No.: US 2023/0401110 A1
(43) Pub. Date: Dec. 14, 2023

(54) TECHNOLOGIES FOR MANAGING ACCELERATOR RESOURCES BY A CLOUD RESOURCE MANAGER

(71) Applicant: Intel Corporation, Santa Clara, CA (US)

(72) Inventors: Malini K. BHANDARU, San Jose, CA (US); Sundar Nadathur, Cupertino, CA (US); Joseph Greeco, Saddle Brook, NJ (US); Roman DOBOSZ, Santa Clara, CA (US); Yongfeng DU, Beijingh (CN)

(21) Appl. No.: 18/456,460

(22) Filed: Aug. 25, 2023

Related U.S. Application Data
(63) Continuation of application No. 16/642,563, filed on Feb. 27, 2020.

(51) Int. Cl. G06F 9/50; H04L 41/0893

(52) U.S. Cl. CPC G06F 9/5083; G06F 9/5044; H04L 41/0893

(57) ABSTRACT

Technologies for managing accelerator resources include a cloud resource manager to receive accelerator usage information from each of a plurality of node compute devices and task parameters of a task to be performed. The cloud resource manager accesses a task distribution policy. The cloud resource manager determines a destination node compute device of the plurality of node compute devices based on the task parameters and the task distribution policy. The cloud resource manager assigns the task to the destination node compute device. Other embodiments are described and claimed.

### RELATED APPLICATIONS

This patent arises from a continuation of U.S. patent application Ser. No. 16/642,563 which was filed on Feb. 27, 2020, which is a national stage entry under 35 USC § 371(b) of International Application No. PCT/CN2017/105035, filed Sep. 30, 2017. U.S. patent application Ser. No. 16/642,563 and PCT/CN2017/105035 are hereby incorporated herein by reference in their entirety. Priority to U.S. patent application Ser. No. 16/642,563 and PCT/CN2017/105035 is hereby claimed.

### BACKGROUND

Certain computing tasks may be performed more quickly by a hardware accelerator, such as a field programmable gate array (FPGA), application specific integrated circuit (ASIC), or graphics processing unit (GPU), than by a central processing unit. Compute devices are increasingly employing hardware accelerators in order to perform suitable computing tasks more quickly.

One drawback with the incorporation of a hardware accelerator into a compute device is that the hardware accelerator may be unused much of the time. Depending on the particular task being performed by the compute device, the hardware accelerator may experience a high level of use some times and have a low usage or be idle at other times, which may be an inefficient allocation of resources. Additionally, reconfiguration of a hardware accelerator may be required fairly often, which may take time and lead to a lower effective utilization of the hardware accelerator.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for managing resources by a cloud resource manager;

FIG. 2 is a simplified block diagram of at least one embodiment of the cloud resource manager of FIG. 1;

FIG. 3 is a simplified block diagram of at least one embodiment of a node compute device of FIG. 1;

FIG. 4 is a simplified block diagram of at least one embodiment of an environment of the cloud resource manager of FIGS. 1 and 2;

FIG. 5 is a simplified block diagram of at least one embodiment of an environment of the node compute device of FIGS. 1 and 3;

FIG. 6 is a simplified flow diagram of at least one embodiment of a method for assigning tasks on the cloud resource manager of FIGS. 1, 2, and 4;

FIGS. 7, 8, and 9 are a simplified flow diagram of at least one embodiment of a method for managing accelerator resources by the node compute device of FIGS. 1, 3, and 5;

FIG. 10 illustrates an domain topology for respective internet-of-things (IoT) networks coupled through links to respective gateways, according to an example;

FIG. 11 illustrates a cloud computing network in communication with a mesh network of IoT devices operating as a fog device at the edge of the cloud computing network, according to an example;

FIG. 12 illustrates a block diagram of a network illustrating communications among a number of IoT devices, according to an example; and

FIG. 13 illustrates a block diagram for an example IoT processing system architecture upon which any one or more of the techniques (e.g., operations, processes, methods, and methodologies) discussed herein may be performed, according to an example.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

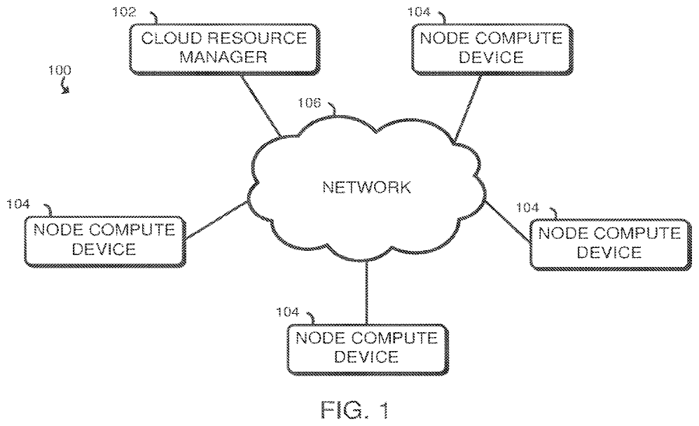

Referring now to FIG. 1, in use, an illustrative system 100 for managing accelerator resources includes a cloud resource manager 102 and one or more node compute devices 104 which are communicatively connected together by an illustrative network 106. The illustrative cloud resource manager 102 is configured to manage accelerator devices 308, such as field programmable gate arrays (FPGAs) on one or more node compute devices 102. Each illustrative node compute device 104 monitors usage of its accelerator device 308, such as by keeping track of what accelerator images or programs are loaded on the accelerator devices 308, free space on the accelerator device 308, frequency of use of the accelerator images that are loaded, and/or the like. Each illustrative node compute device 104 sends usage information of its accelerator devices 308 to the cloud resource manager 102, which stores the accelerator usage information of each node compute device 104.

The illustrative cloud resource manager 102 may receive task parameters of tasks that are to be performed by an accelerator device 308 of one of the node compute devices 104. A task may be any task suitable for being performed on an accelerator device 308, such as training a deep learning algorithm, performing a block chain computation, performing k-means clustering, etc. Task parameters may be sent by one of the node compute devices 104 or by other compute devices not shown in FIG. 1. Task parameters may include a specification of the accelerator image or bitstream to be implemented, task data to be processed, specific hardware requirements, and/or the like. The cloud resource manager 102 analyzes the task parameters and determines which node compute device(s) 104 would be suitable for performing the task. The cloud resource manager 102 may consider factors such as which node compute device(s) 104 already have the specified accelerator image or bitstream loaded in an accelerator device 308, which may result in a more efficient allocation of resources since reimaging of the accelerator devices 308 may not be required. In doing such an analysis, the cloud resource manager 102 may consider a task distribution policy, which may specify certain rules or priorities for how tasks should be assigned. In the illustrative embodiment, the cloud resource manager 102 assigns a task to one or more node compute devices 104 by sending a list or other identification information of the one or more node compute devices 104 to the requesting device which sent the task parameters to the cloud resource manager 102. The requesting device may then select one of the node compute devices 104 to perform the task. Additionally or alternatively, the cloud resource manager 102 may directly assign a task to a node compute device 104 by sending task parameters and other relevant information directly to the node compute device 104.

As shown in FIG. 1, the system 100 includes the cloud resource manager 102, the node compute device 104, and a network 106. The system 100 may be embodied as a datacenter, a cloud computing system, a cluster of computers, and/or the like. It should be appreciated that the various components of the system 100 need not be physically located in the same location, but rather may be spread in several different locations.

The cloud resource manager 102 may be embodied as any type of computation or computer device capable of performing the functions described herein, including, without limitation, a computer, a server, a rack-mounted server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. It should be appreciated that, in some embodiments, the cloud resource manager 102 may not be exclusively dedicated to performing the cloud resource management functionality described herein. For example, the cloud resource management functionality described herein may be performed by a virtual machine or container running alongside other processes or software on the cloud resource manager 102.

The node compute device 104 may be embodied as any type of computing device capable of performing the functions described herein. For example, the node compute device 104 may be embodied as a blade server, rack mounted device, desktop computer, cellular phone, smartphone, tablet computer, netbook, notebook, Ultrabook™, laptop computer, personal digital assistant, mobile Internet device, Hybrid device, and/or any other computing/communication device.

The network 106 may be embodied as any type of network capable of facilitating communications between the cloud resource manager 102 and the node compute devices 104 and/or other remote devices. For example, the network 106 may be embodied as, or otherwise include, a wired or wireless local area network (LAN), a wired or wireless wide area network (WAN), a cellular network, and/or a publicly-accessible, global network such as the Internet. As such, the network 106 may include any number of additional devices, such as additional computers, routers, and switches, to facilitate communications thereacross.

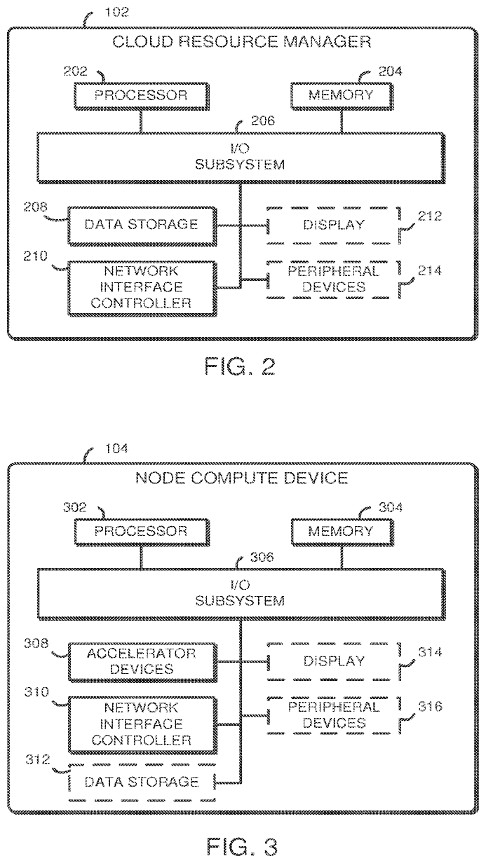

Referring now to FIG. 2, an illustrative cloud resource manager 102 for managing accelerator resources includes a processor 202, a memory 204, an input/output (“I/O”) subsystem 206, a data storage 208, and a network interface controller 210. In some embodiments, the cloud resource manager 102 may include a display 212 and peripheral devices 214. Of course, the cloud resource manager 102 may include other or additional components, such as those commonly found in a typical computing device (e.g., various input/output devices), in other embodiments. Additionally, in some embodiments, one or more of the illustrative components may be incorporated in, or otherwise from a portion of, another component. For example, the memory 204, or portions thereof, may be incorporated in the processor 202 in some embodiments.

The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the cloud resource manager 102 such as operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the cloud resource manager 102. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the cloud resource manager 102, on a single integrated circuit chip.

The data storage 208 may be embodied as any type of device or devices configured for short-term or long-term storage of data such as, for example, memory devices and circuits, memory cards, hard disk drives, solid-state drives, or other data storage devices. The network interface controller 210 may be embodied as any communication circuit, device, or collection thereof, capable of enabling communications between the cloud resource manager 102 and other remote devices over a network 106. To do so, the network interface controller 210 may use any suitable communication technology (e.g., wireless or wired communications) and associated protocol (e.g., Ethernet, Bluetooth®, Wi-Fi®, WiMAX, etc.) to effect such communication depending on, for example, the type of network, which may be embodied as any type of communication network capable of facilitating communication between the cloud resource manager 102 and remote devices.

In some embodiments, the cloud resource manager 102 may include a display 212, which may be embodied as, or otherwise use, any suitable display technology including, for example, a liquid crystal display (LCD), a light emitting diode (LED) display, a cathode ray tube (CRT) display, a plasma display, and/or other display technology. The display 212 may be used, for example, to display information to an administrator. Although shown in FIG. 2 as integral to the cloud resource manager 102, it should be appreciated that the display 212 may be remote from the cloud resource manager 102 but communicatively coupled thereto in other embodiments.

In some embodiments, the cloud resource manager 102 may include peripheral devices 214, which may include any number of additional input/output devices, interface devices, and/or other peripheral devices. For example, in some embodiments, the peripheral devices 214 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices. The particular devices included in the peripheral devices 214 may depend on, for example, the type and/or intended use of the cloud resource manager 102.

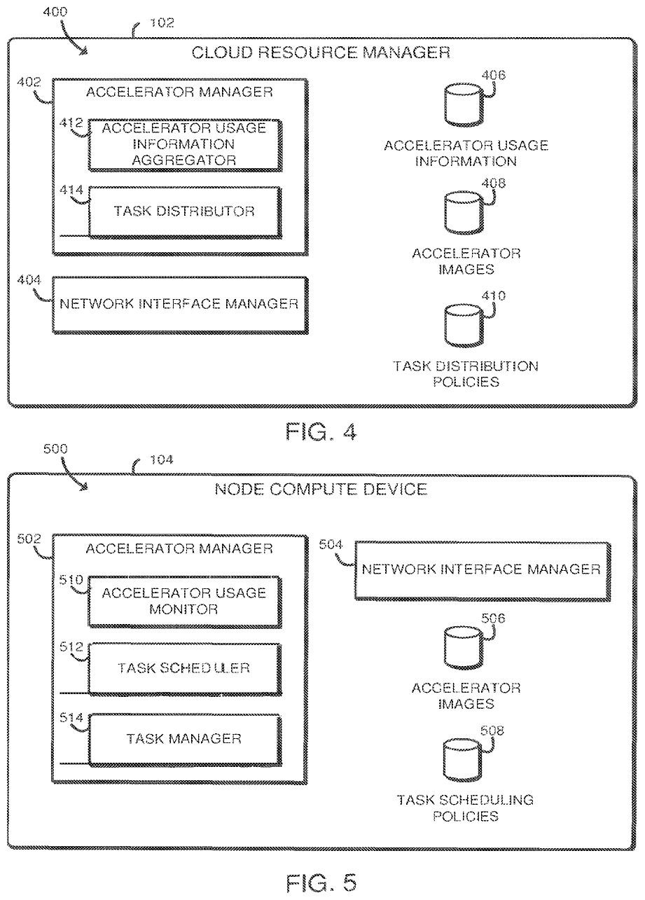

Referring now to FIG. 3, an illustrative node compute device 104 for managing accelerator resources includes a processor 302, a memory 304, an input/output (“I/O”) subsystem 306, one or more accelerator devices 308, and a network interface controller 310. In some embodiments, the node compute device 104 may include a data storage 312, a display 214, and peripheral devices 316. Of course, the node compute device 104 may include other or additional components, such as those commonly found in a typical computing device (e.g., various input/output devices), in other embodiments. Additionally, in some embodiments, one or more of the illustrative components may be incorporated in, or otherwise from a portion of, another component. For example, the memory 304, or portions thereof, may be incorporated in the processor 302 in some embodiments.

The processor 302 may be embodied as any type of processor capable of performing the functions described herein. For example, the processor 302 may be embodied as a single or multi-core processor(s), digital signal processor, microcontroller, or other processor or processing/controlling circuit. Similarly, the memory 304 may be embodied as any type of volatile or non-volatile memory or data storage capable of performing the functions described herein. In operation, the memory 304 may store various data and software used during operation of the node compute device 104 such as operating systems, applications, programs, libraries, and drivers. The memory 304 is communicatively coupled to the processor 302 via the I/O subsystem 306, which may be embodied as circuitry and/or components to facilitate input/output operations with the processor 302, the memory 304, and other components of the node compute device 104. For example, the I/O subsystem 306 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 306 may form a portion of a system-on-a-chip (SoC) and be incorporated, along with the processor 302, the memory 304, and other components of the node compute device 104, on a single integrated circuit chip.

The one or more accelerator devices 308 may be embodied as any type of device configured or configurable to perform a specialized computing task. For example, the accelerator device 1312 may be particularly well suited for tasks such as training a deep learning algorithm, performing a block chain computation, performing k-means clustering, encryption, image processing, etc. The accelerator devices 308 may be embodied as, for example, a field programmable gate array (FPGA), an application specific integrated circuit (ASIC), a graphics processing unit (GPU), a configurable array of logic blocks in communication over a configurable data interchange, etc. An accelerator device 308 that is reconfigurable can load an accelerator image which defines the functionality and/or settings of the accelerator device 308. For example, an accelerator image may configure the logic gates in an FPGA. An accelerator image may also be referred to as a bitstream, a program, and/or the like. In some embodiments, the accelerator devices 308 can save workload state without changing the accelerator image in a similar manner as context-switching in a processor. Each of the accelerator devices 308 may have multiple programmable slots that may vary in size. That is, the accelerator devices 308 may be partitioned into programmable slots that are different in size depending on the accelerator image. Each of the accelerator devices 308 may have fast non-volatile memory for paging in/out accelerator images, used as a holding zone for images not actively used. In some embodiments, the node compute device 104 may include fast non-volatile memory instead of or in addition to the accelerator device 308 including fast non-volatile memory. The accelerator devices 308 may be coupled to the processor 302 via a high-speed connection interface such as a peripheral bus (e.g., a PCI Express bus) or an inter-processor interconnect (e.g., an in-die interconnect (IDI) or QuickPath Interconnect (QPI)), via a fabric interconnect such as Intel® Omni-Path Architecture, or via any other appropriate interconnect.

The network interface controller 310 may be embodied as any communication circuit, device, or collection thereof, capable of enabling communications between the node compute device 104 and other remote devices over a network 106. To do so, the network interface controller 310 may use any suitable communication technology (e.g., wireless or wired communications) and associated protocol (e.g., Ethernet, Bluetooth®, Wi-Fi®, WiMAX, etc.) to effect such communication depending on, for example, the type of network, which may be embodied as any type of communication network capable of facilitating communication between the node compute device 104 and remote devices.

In some embodiments, the node compute device 104 may include a data storage 312, which may be embodied as any type of device or devices configured for short-term or long-term storage of data such as, for example, memory devices and circuits, memory cards, hard disk drives, solid-state drives, or other data storage devices.

In some embodiments, the node compute device 104 may include a display 314, which may be embodied as, or otherwise use, any suitable display technology including, for example, a liquid crystal display (LCD), a light emitting diode (LED) display, a cathode ray tube (CRT) display, a plasma display, and/or other display technology. The display 314 may be used, for example, to display information to an administrator. Although shown in FIG. 2 as integral to the node compute device 104, it should be appreciated that the display 314 may be remote from the node compute device 104 but communicatively coupled thereto in other embodiments.

In some embodiments, the node compute device 104 may include peripheral devices 316, which may include any number of additional input/output devices, interface devices, and/or other peripheral devices. For example, in some embodiments, the peripheral devices 316 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices. The particular devices included in the peripheral devices 316 may depend on, for example, the type and/or intended use of the node compute device 104.

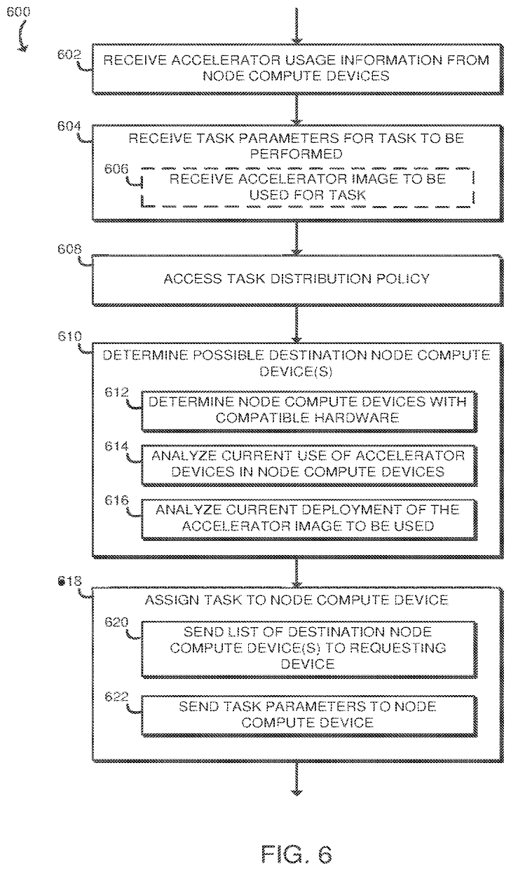

Referring now to FIG. 4, in use, the cloud resource manager 102 establishes an environment 400 for managing accelerator resources. As discussed below, the cloud resource manager 102 determines an efficient way of assigning tasks to the accelerator devices 308. In the illustrative environment 400, the cloud resource manager 102 includes an accelerator manager 402, a network interface manager 404, accelerator usage information 406, accelerator images 408, and task distribution policies 410. Additionally, the accelerator manager 402 includes an accelerator usage information aggregator 412 and a task distributor 414. Each of the accelerator manager 402, the network interface manager 404, the accelerator usage information 406, the accelerator images 408, the task distribution policies 410, the accelerator usage information aggregator 412, and the task distributor 414 may be embodied as hardware, software, firmware, or a combination thereof. Additionally, in some embodiments, one of the illustrative components may form a portion of another component.

The accelerator manager 402 may in some embodiments be implemented as a daemon or driver that lends itself to queries, such as a RESTful interface. The accelerator manager 402 manages the accelerator resources within the system 100 by assigning tasks to accelerator devices 308 of the node compute devices 104 or providing identification information of node compute devices 104 with suitable accelerator devices 308 to a requestor. To do so, the accelerator usage information aggregator 412 tracks the accelerator usage information 406 within the system 100. The accelerator usage information 406 may include telemetry data received from the node compute devices 104, such as properties of deployment of accelerator images, such as what accelerator images are deployed, which node compute device 104 has a given accelerator image loaded, whether the accelerator image is shareable (available to anyone or just to the user or the compute device which sent the task), the fraction of time each loaded accelerator image is used, the amount of free space in each accelerator device 308, associated cost of using the accelerator images, hardware parameters (such as speed, size, memory, power required, etc.), priority of current tasks, and how often certain accelerator images are used or when the accelerator images were last used. The accelerator usage information aggregator 412 aggregates the accelerator usage information 406 in order to determine an efficient way to assign tasks to accelerator devices 308 of node compute devices 104. For example, the accelerator usage information aggregator 412 may determine which accelerator images are currently loaded on which accelerator devices 308 and determine a degree of usage to determine whether a task should be assigned to a particular accelerator device 308 that contains the accelerator image to perform the task. The accelerator usage information 406 may be pulled from the node compute devices 104 by the cloud resource manager 102 or pushed to the cloud resource manager 102 by the node compute device 104.

As described above, the accelerator images 408 may be embodied as a bitstream, a program, etc. The accelerator images 408 may be stored on the cloud resource manager 102 or the node compute devices 104. The cloud resource manager 102 or the node compute devices 104 may have a repository or library of generally-available or popular accelerator images 408. In some embodiments, the accelerator images 408 may be stored if they were used in previous task requests and may be available only with a password, etc. The cloud resource manager 102 may store metadata for the accelerator images 408 that include a size, power usage, and whether the corresponding accelerator image is permitted to be shared.

In conjunction with aggregating the accelerator usage information 406, the task distributor 414 receives incoming tasks. These tasks may be received from a user, another device in the same data center, or any compute device in communication with the system 100. Reception of the tasks includes task parameters such as task data, which accelerator image 408 should be used to perform the task, hardware resource requirements, resources required besides accelerator devices 308 such as a virtual machine to be run during execution of the accelerator devices 308, etc. In some instances, the task distributor 414 may receive an accelerator image 408 to perform the task. In some embodiments, a plurality of accelerator images 408 may be stored on the node compute devices 104 to be selected to perform the task. The task distributor 414 distributes the incoming tasks to suitable node compute devices 104 based on task parameters and task distribution policies 410 which may be determined by an administrator or for example, a service level agreement. The task distribution policies 410 may include policies that specify particular goals using metrics and techniques similar to cache management policies, such as least recently used (LRU), most recently used (MRU), least frequently used (LFU), and process priority. The goals could be, e.g., least left over space in an accelerator device 308, most left over space in an accelerator device 308, compliance with power budgets where a given node compute device 104 or accelerator device 308 may have a particular power budget. In some embodiments, scheduling decisions may be carried out by the cloud resource manager 102, by the node compute devices 104, or jointly between cloud resource manager 102 and the node compute devices 104. Additionally or alternatively, a third party scheduling decision system can have thresholds to determine when to launch another instance of a particular algorithm (e.g., requested usage over 90% of what is available). An example distribution of a task may include the task distributor 414 finding which node compute devices 104 currently have the requested accelerator image 408 to perform the task and have available time for a task to be run on the accelerator image 408. Several factors the task distributor 414 may consider include which node compute devices 104 have the requested accelerator image 408, the resource availability of the requested accelerator image 408 (if there is a queue), how long is the queue, whether the requested accelerator image 408 is likely to be swapped out soon, and free resource availability and whether the accelerator image 408 can fit in the free resource. However, if there are no free resources available, the task distributor 414 may determine what node compute devices 104 have the shortest queue or have tasks with a lower priority than the current task. When an accelerator workload or task is received that does not fit in any available free blocks, the task distributor 414 may determine whether a host has adequate total free space, and whether to defragment and then host the accelerator image 408 or if there is a contiguous block of adequate size currently occupied by an accelerator image 408 that is not frequently used, the task distributor 414 may page out the accelerator image 408 that is not frequently used and launch the new task and page back in the previous accelerator image 408 whenever necessary. In some embodiments, the task distributor 414 may make assignments/recommendations based on high-level usage details and leaving details to the node compute devices 104, such as which specific accelerator devices 308 should implement the task and how to reimage or defragment accelerator devices 308. Alternatively, the task distributor 414 may exercise more or complete control on how and when tasks are performed on node compute devices 104.

The network interface manager 404 manages the communication between the cloud resource manager 102 and the node compute devices 104 and the other devices on the network 106. To do so, the network interface manager 404 may use the NIC 210 to communicate with the other devices of the system 100. The network interface manager 404 may send and receive appropriate data to perform the functions described herein.

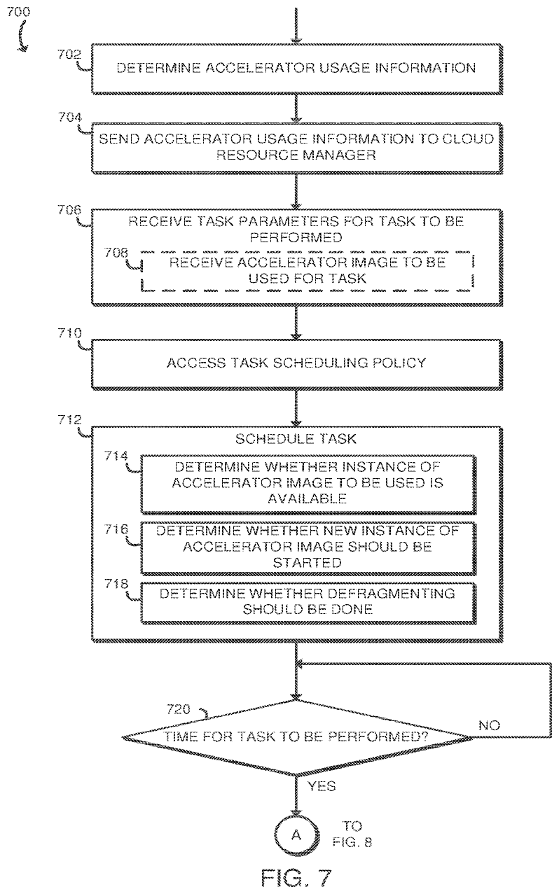

Referring now to FIG. 5, in use, the node compute device 104 establishes an environment 500 for managing accelerator resources. As discussed below, the node compute device 104 determines an efficient way of assigning tasks to the accelerator devices 308. In the illustrative environment 500, the node compute device 104 includes an accelerator manager 502, a network interface manager 504, accelerator images 506, and task scheduling policies 508. Additionally, the accelerator manager 502 includes an accelerator usage monitor 510, a task scheduler 512, and a task manager 514. Each of the accelerator manager 502, the network interface manager 504, the accelerator images 506, the task scheduling policies 508, the accelerator usage monitor 510, the task scheduler 512, and the task manager 514 may be embodied as hardware, software, firmware, or a combination thereof. Additionally, in some embodiments, one of the illustrative components may form a portion of another component.

The accelerator manager 402 manages the accelerator resources within the node compute device 104 by assigning tasks to accelerator devices 308 or providing information of accelerator devices 308 of the node compute devices 104 to a requestor. The accelerator usage monitor 510 may monitor and report usage, fragmentation, which accelerator images are deployed where, power usage levels, etc., for accelerator devices 308. If the node compute device 104 is over a power budget, the accelerator usage monitor 510 may trigger an alert, cancel operations, or take other appropriate actions. The accelerator usage monitor 510 may also monitor and report the resource availability and usage for scheduling decisions, billing purposes, inventory management, etc. The node compute device 104 may push changes to the cloud resource manager 102 or the cloud resource manager 102 may pull the changes from the node compute device 104.

The task scheduler 512 may receive tasks assigned by the cloud resource manager 102. The task scheduler 512 may receive task parameters such as task data, which of the accelerator images 506 should be used to perform the task, hardware resource requirements, resources required besides accelerator devices 308 such as a virtual machine to be run during execution of the accelerator devices 308, etc. In some instances, the task scheduler 512 may receive an accelerator image 506 to perform the task. As described above, the accelerator images 506 may be embodied as a bitstream, a program, etc. In some embodiments, one or more accelerator images 506 may be stored on the node compute devices 104 to be selected to perform the task. The node compute device 104 may have a repository or library of generally-available or popular accelerator images 506 and/or locally cached accelerator images 506 that have recently been used or are frequently used. In some embodiments, the accelerator images 506 may be stored if they were used in previous task requests and may be available only after an authentication and authorization process, etc. The node compute device 104 may store metadata for the accelerator images 506 that include a size, power usage, and whether the corresponding accelerator image is permitted to be shared. The task scheduler 512 may schedule tasks based on priority, task scheduling policies 508, billing, usage of current jobs, etc., and may place tasks in a queue, select a particular slot, etc. The task scheduling policies 508 can use techniques similar to cache management policies, such as least recently used (LRU), most recently used (MRU), least frequently used (LFU), and process priority. In some embodiments, the task scheduler 512 may involve the cloud resource manager 102 in the task scheduling.

The task manager 514 may set up and perform tasks through the accelerator devices 308. To set up the tasks, the task manager 514 may load accelerator images 506, which may require defragmenting an accelerator device 308. In some embodiments, swapped out images with or without state and context data may be saved to a fast non-volatile memory for fast swapping in/out of the accelerator images 506. The set up of the tasks may also include loading a virtual machine (VM) or container to interact with the accelerator device 308. Set up may include switching out currently-running tasks on the same accelerator image 506, similar to context switching in processors. The task manager 514 may send the resulting data to the requesting compute device.

The network interface manager 504 manages the communication between the node compute device 104 and the cloud resource manager 102 and the other devices on the network 106. To do so, the network interface manager 504 may use the NIC 310 to communicate with the other devices of the system 100. The network interface manager 504 may send and receive appropriate data to perform the functions described herein.

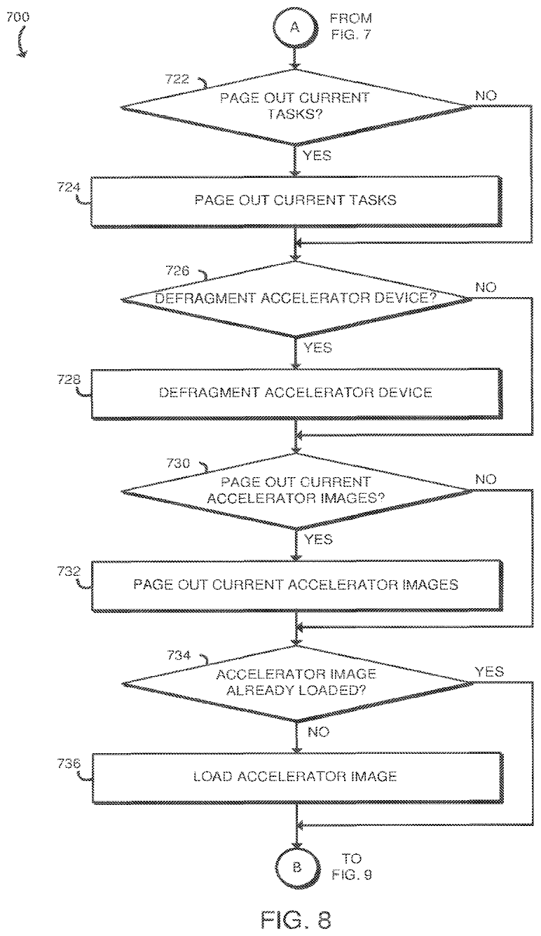

Referring now to FIG. 6, in use, the cloud resource manager 102 may execute a method 600 for managing accelerator resources. The illustrative method 600 begins with block 602 of FIG. 6 in which the cloud resource manager 102 receives accelerator usage information from node compute devices 104. To do so, the node compute devices 104 may send the accelerator usage information to the cloud resource manager 102 or the cloud resource manager 102 may pull accelerator usage information from the node compute devices 104. The accelerator usage information may include properties of deployment of accelerator images, such as what accelerator images are deployed, which node compute device 104 is performing which accelerator images, whether the accelerator images are shareable (available to anyone to user or only available to the compute device which sent the task), the function's host platform utilization, a degree of usage or how much free space there is for each accelerator device, associated cost of the functions, hardware parameters (such as speed, size, memory, power required, etc.), priority of the tasks being performed, and how often certain accelerator images are used or when the accelerator images were last used.

In block 604, the cloud resource manager 102 may receive task parameters for tasks to be performed. Reception of the task parameters include receiving task data such as a general algorithm to apply, specific instance to be executed on, desired platform, which accelerator image should be used to perform the task, hardware resource requirements, resources required besides accelerator devices such as for a virtual machine to be run during execution of the accelerator devices, etc. The cloud resource manager 102 may either manage the tasks or merely respond to a request for a recommendation. In some embodiments, in block 606, the cloud resource manager 102 may receive an accelerator image to be used for the received task.

In block 608, the cloud resource manager 102 accesses a task distribution policy. The task distribution policy, which may be determined by, e.g., an administrator or a service level agreement may include policies that specify particular goals using metrics and techniques similar to cache management policies, such as least recently used (LRU), most recently used (MRU), least frequently used (LFU), and process priority. The goals could be, e.g., least left over space in an accelerator device, most left over space in an accelerator device, or compliance with power budgets where a given node compute device 104 or accelerator device may have a particular power budget, when to add new instances, what to do when instance cannot fit in the current configuration, such as defragment an accelerator device 308 or page out an accelerator image.

In block 610, the cloud resource manager 102 determines possible destination node compute device(s) 104. To do so, the cloud resource manager 102 determines the node compute device(s) 104 that have compatible hardware in block 612. A goal of the cloud resource manager 102 that may be considered is the least left over space or most left over space and power considerations. In block 614, the cloud resource manager 102 analyzes the current use of accelerator devices 308 in node compute devices 104. In block 616, the cloud resource manager 102 analyzes the current deployment of the accelerator image to be used. The cloud resource manager 102 may determine how to deal with no available block big enough for the accelerator image necessary to perform the task by either defragmenting or paging out an accelerator image if the accelerator image to be used is not currently deployed. The cloud resource manager 102 may determine new instances should be added and ignore non-shareable instances of the accelerator image. For example, the cloud resource manager 102 may determine in block 610 that an instance of the requested accelerator image is already loaded and is currently unused and shareable, and the cloud resource manager 102 may then determine that the corresponding node compute device 104 would be a suitable destination. In another example, the cloud resource manager 102 may determine in block 610 that an instance of the requested accelerator image is already loaded and is in use by a task with lower priority that the incoming task, and the cloud resource manager 102 may then determine that the corresponding node compute device 104 would be a suitable destination. In an additional example, the cloud resource manager 102 may determine in block 610 that an instance of the requested accelerator image is not loaded in a given accelerator device 308 but that there is free space on the accelerator device 308 for the accelerator image, and the cloud resource manager 102 may then determine that the corresponding node compute device 104 would be a suitable destination. In yet another example, the cloud resource manager 102 may determine in block 610 that there would be free space in a given accelerator device 308 if the accelerator device was defragmented, and the cloud resource manager 102 may then determine that the corresponding node compute device 104 would be a suitable destination.

In block 618, the cloud resource manager 102 assigns the task to a node compute device 104. In the illustrative embodiment, to do so, in block 620, the cloud resource manager 102 sends a list of destination node compute device(s) 104 to a requesting device, which can then communicate directly with the node compute device(s) 104. Additionally or alternatively, in some embodiments, the cloud resource manager 102 may send task parameters directly to a node compute device 104 to perform the task with an accelerator device in block 622.

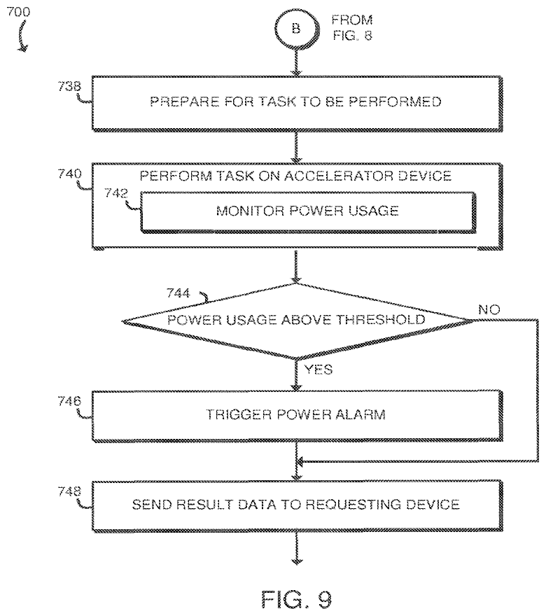

Referring now to FIG. 7, in use, the node compute device 104 may execute a method 700 for managing accelerator resources. The illustrative method 700 begins with block 702 where the node compute device 104 determines accelerator usage information. The accelerator usage information may include properties of deployment of accelerator images, such as what accelerator images are deployed, which node compute device 104 is performing the accelerator image, whether the accelerator image is shareable (available to anyone to user or only available to the compute device which sent the task), the accelerator image's utilization, a degree of usage or how much free space there is for each accelerator device, associated cost of the functions, hardware parameters (such as speed, size, memory, power required, etc.), priority of the tasks currently being performed, and how often certain accelerator images are used or when the accelerator images were last used.

In block 704, the node compute device 104 sends the accelerator usage information to the cloud resource manager 102. The transfer of accelerator usage information may be initialized by the cloud resource manager 102 or by the node compute device 104.

In block 706, the node compute device 104 receives task parameters for tasks to be performed. In some embodiments, the node compute device 104 may receive the task from the cloud resource manager 102. Alternatively, the node compute device 104 may receive the task directly from requesting compute device(s). Example tasks may include deep learning algorithms, block chain computation, compute k-means, etc. In some embodiments, in block 708, the node compute devices 104 may receive an accelerator image to be used for the task.

In block 710, the node compute device 104 accesses a task scheduling policy. The task scheduling policies can use techniques similar to cache management policies, such as least recently used (LRU), most recently used (MRU), least frequently used (LFU), and process priority. The task scheduling policy may specify certain goals, such as, e.g., least left over space in an accelerator device 308, most left over space in an accelerator device 308, compliance with power budgets where a given node compute device 104 or accelerator device 308 may have a particular power budget, etc.

In block 712, the node compute device 104 schedules the requested task. In block 714, the node compute device 104 determines whether an instance of the accelerator image to be used is available. In block 716, the node compute device 104 determines whether a new instance of the accelerator image should be started. The node compute device 104 may determine that a new instance of the accelerator should be started if the requests for a given instance of an accelerator image exceed the capacity of the accelerator image. In block 718, the node compute device 104 determines whether defragmenting should be done to set up the accelerator image.

In block 720, the node compute device 104 determines whether it is time to perform the task (e.g., whether previously-scheduled tasks have completed, whether the scheduled time has arrived, or whether a set of conditions determined in the scheduling have otherwise been met). If the node compute device 104 determines that it is time to perform the requested task, the method 700 advances to block 722 of FIG. 8. However, if the node compute device 104 determines that it is not time for the task to be performed, the method 700 loops back to the start of block 720 to continually check until it is time for the task to be performed.

In block 722, in FIG. 8, the node compute device 104 determines whether to page out current tasks. If the node compute device 104 determines that a page out is needed, the node compute device 104 pages out the current tasks in block 724. To do so, the node compute device 104 may save the context data of the task currently being performed on the accelerator device 308. In some embodiments, the node compute device 104 may determine that the task currently being performed should be moved to a second node compute device 104. In such embodiments, the node compute device 104 may send the context data to the second compute device 104, which can then continue performance of the task. However, if the node compute device 104 determines no page out is necessary, the method 700 advances to block 726.

In block 726, the node compute device 104 determines whether to defragment the accelerator device. If the node compute device 104 determines to defragment the accelerator device, the node compute device defragments the accelerator device in block 728. The node compute device 104 may determine that defragmenting should be done if an accelerator device 308 has some free space, but the free space is distributed between gaps of other accelerator images loaded on the accelerator device 308. By moving accelerator images to be closer together, the free space of the accelerator device 308 can be grouped together, allowing for a new accelerator image to be loaded. However, if the node compute device 104 determines there is no need to defragment the accelerator device, the method 700 advances to block 730.

In block 730, the node compute device 104 determines whether to page out current accelerator images. If the node compute device 104 determines to page out current accelerator images, the node compute device pages out current accelerator images in block 732. The node compute device 104 may page out the current accelerator images to a non-volatile flash memory. If the node compute device 104 determines that there is no need to page out the current accelerator images, the node compute device 104 advances to block 734.

In block 734, the node compute device 104 determines whether there is an accelerator image already loaded where the task is to be performed. If the node compute device 104 determines that there is not an accelerator image already loaded where the task is to be performed, the node compute device 104 loads the accelerator image in block 736. If the node compute device 104 determines the accelerator image is already loaded, the method 700 advances to block 738 of FIG. 9.

In block 738, in FIG. 9, the node compute device 104 prepares for the task to be performed. To do so, the node compute device 104 may load task parameters. In addition, the node compute device 104 may load a virtual machine (VM) or container to interact with the accelerator device.

In block 740, the node compute device 104 performs the task on the accelerator device. In some embodiments, the node compute device 104 may send a notification to the cloud resource manager 102 and/or the requesting device that the task has been launched. While performing the task on the accelerator device, the node compute device 104 may monitor the power usage in block 742.

In block 744, the node compute device 104 determines whether the power usage is above a threshold. If the node compute device 104 determines the power usage is above a threshold, the node compute device triggers a power alarm in block 746. In response to the power alarm, the node compute device 104 may stop the task, pause the task, or take other appropriate action. Although shown as occurring in block 746, it should be appreciated that power monitoring may, in some embodiments, be performed continuously, continually, or periodically. If the node compute device 104 determines the power usage is not above a threshold, the node compute device 104 proceeds with performing the task and sends the result data to the requesting device in block 748. The result data may be sent to the cloud resource manager 102 or the result data may be sent directly to the requesting device. Of course, it should be appreciated that the task may not necessarily be performed all at once, but may be interrupted by other tasks and may be paged out and paged back in at a later time. In some embodiments, result data may be generated at multiple different times and sending result data may not necessarily be done only at the completion of the task.

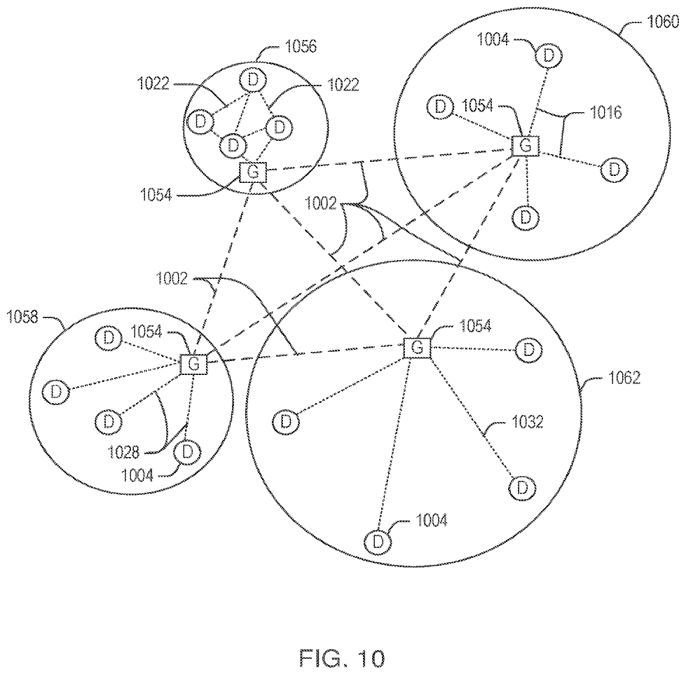

Referring now to FIGS. 10-13, in some embodiments, some or all of the technology described above may be embodied as or interact with one or more internet-of-things devices. FIG. 10 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

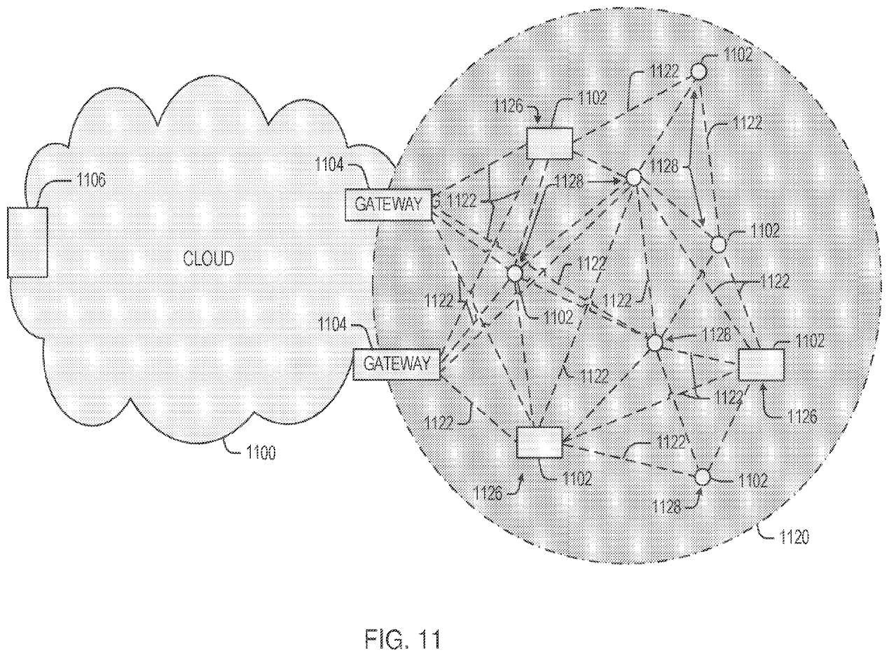

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 10 and 11, present a number of new challenges in a heterogeneous network of connectivity comprising a combination of wired and wireless technologies.

FIG. 10 specifically provides a simplified drawing of a domain topology that may be used for a number of internet-of-things (IoT) networks comprising IoT devices 1004, with the IoT networks 1056, 1058, 1060, 1062, coupled through backbone links 1002 to respective gateways 1054. For example, a number of IoT devices 1004 may communicate with a gateway 1054, and with each other through the gateway 1054. To simplify the drawing, not every IoT device 1004, or communications link (e.g., link 1016, 1022, 1028, or 1032) is labeled. The backbone links 1002 may include any number of wired or wireless technologies, including optical networks, and may be part of a local area network (LAN), a wide area network (WAN), or the Internet. Additionally, such communication links facilitate optical signal paths among both IoT devices 1004 and gateways 1054, including the use of MUXing/deMUXing components that facilitate interconnection of the various devices.

The network topology may include any number of types of IoT networks, such as a mesh network provided with the network 1056 using Bluetooth low energy (BLE) links 1022. Other types of IoT networks that may be present include a wireless local area network (WLAN) network 1058 used to communicate with IoT devices 1004 through IEEE 802.11 (Wi-Fi®) links 1028, a cellular network 1060 used to communicate with IoT devices 1004 through an LTE/LTE-A (4G) or 5G cellular network, and a low-power wide area (LPWA) network 1062, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 1004, such as over the backbone links 1002, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 1056, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1058, for instance, may use systems that perform standards conversion to provide multi-standard connectivity, enabling IoT devices 1004 using different protocols to communicate. Further systems may provide seamless interconnectivity across a multi-standard infrastructure comprising visible Internet resources and hidden Internet resources.

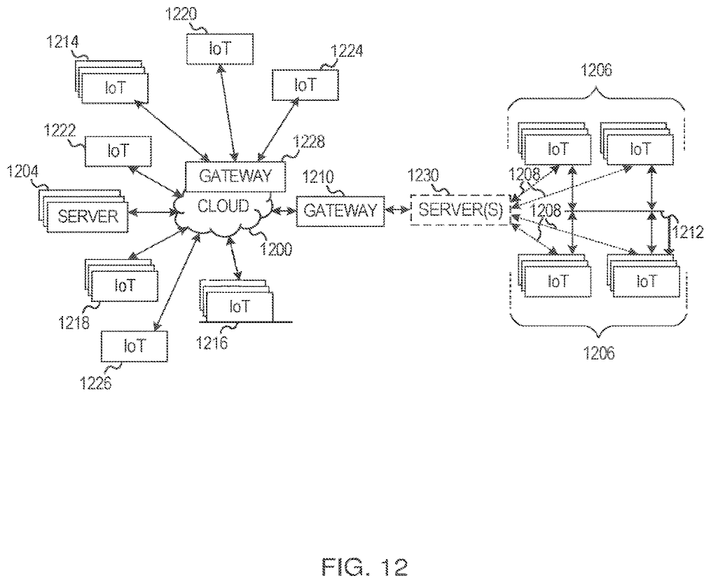

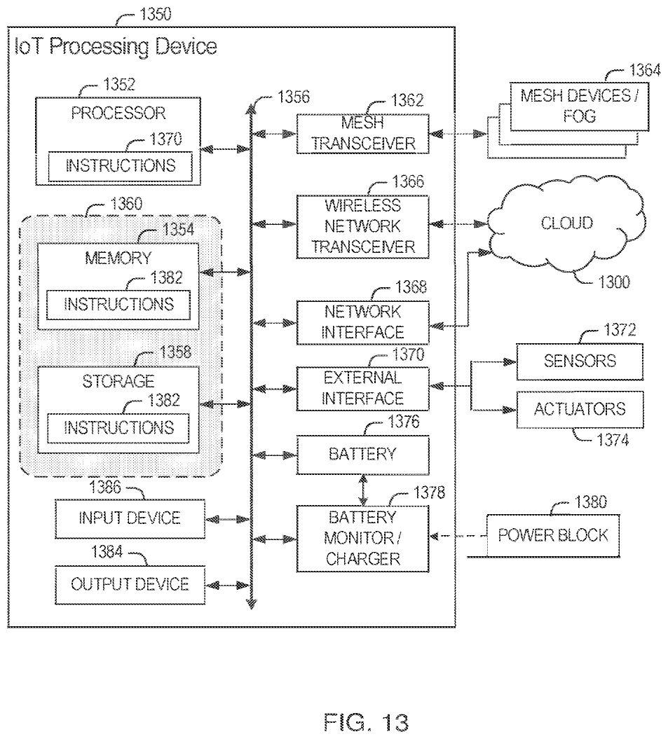

Communications in the cellular network 1060, for instance, may be enhanced by systems that offload data, extend communications to more remote devices, or both. The LPWA network 1062 may include systems that perform non-Internet protocol (IP) to IP interconnections, addressing, and routing. Further, each of the IoT devices 1004 may include the appropriate transceiver for wide area communications with that device. Further, each IoT device 1004 may include other transceivers for communications using additional protocols and frequencies. This is discussed further with respect to the communication environment and hardware of an IoT processing device depicted in FIGS. 12 and 13.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 11 below.

FIG. 11 illustrates a cloud computing network in communication with a mesh network of IoT devices (devices 1102) operating as a fog device at the edge of the cloud computing network. The mesh network of IoT devices may be termed a fog 1120, operating at the edge of the cloud 1100. To simplify the diagram, not every IoT device 1102 is labeled.

The fog 1120 may be considered to be a massively interconnected network wherein a number of IoT devices 1102 are in communications with each other, for example, by radio links 1122. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1102 are shown in this example, gateways 1104, data aggregators 1126, and sensors 1128, although any combinations of IoT devices 1102 and functionality may be used. The gateways 1104 may be edge devices that provide communications between the cloud 1100 and the fog 1120, and may also provide the backend process function for data obtained from sensors 1128, such as motion data, flow data, temperature data, and the like. The data aggregators 1126 may collect data from any number of the sensors 1128, and perform the back end processing function for the analysis. The results, raw data, or both may be passed along to the cloud 1100 through the gateways 1104. The sensors 1128 may be full IoT devices 1102, for example, capable of both collecting data and processing the data. In some cases, the sensors 1128 may be more limited in functionality, for example, collecting the data and allowing the data aggregators 1126 or gateways 1104 to process the data.

Communications from any IoT device 1102 may be passed along a convenient path (e.g., a most convenient path) between any of the IoT devices 1102 to reach the gateways 1104. In these networks, the number of interconnections provide substantial redundancy, allowing communications to be maintained, even with the loss of a number of IoT devices 1102. Further, the use of a mesh network may allow IoT devices 1102 that are very low power or located at a distance from infrastructure to be used, as the range to connect to another IoT device 1102 may be much less than the range to connect to the gateways 1104.

The fog 1120 provided from these IoT devices 1102 may be presented to devices in the cloud 1100, such as a server 1106, as a single device located at the edge of the cloud 1100, e.g., a fog device. In this example, the alerts coming from the fog device may be sent without being identified as coming from a specific IoT device 1102 within the fog 1120. In this fashion, the fog 1120 may be considered a distributed platform that provides computing and storage resources to perform processing or data-intensive tasks such as data analytics, data aggregation, and machine-learning, among others.

In some examples, the IoT devices 1102 may be configured using an imperative programming style, e.g., with each IoT device 1102 having a specific function and communication partners. However, the IoT devices 1102 forming the fog device may be configured in a declarative programming style, allowing the IoT devices 1102 to reconfigure their operations and communications, such as to determine needed resources in response to conditions, queries, and device failures. As an example, a query from a user located at a server 1106 about the operations of a subset of equipment monitored by the IoT devices 1102 may result in the fog 1120 device selecting the IoT devices 1102, such as particular sensors 1128, needed to answer the query. The data from these sensors 1128 may then be aggregated and analyzed by any combination of the sensors 1128, data aggregators 1126, or gateways 1104, before being sent on by the fog 1120 device to the server 1106 to answer the query. In this example, IoT devices 1102 in the fog 1120 may select the sensors 1128 used based on the query, such as adding data from flow sensors or temperature sensors. Further, if some of the IoT devices 1102 are not operational, other IoT devices 1102 in the fog 1120 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 12 illustrates a drawing of a cloud computing network, or cloud 1200, in communication with a number of Internet of Things (IoT) devices. The cloud 1200 may represent the Internet, or may be a local area network (LAN), or a wide area network (WAN), such as a proprietary network for a company. The IoT devices may include any number of different types of devices, grouped in various combinations. For example, a traffic control group 1206 may include IoT devices along streets in a city. These IoT devices may include stoplights, traffic flow monitors, cameras, weather sensors, and the like. The traffic control group 1206, or other subgroups, may be in communication with the cloud 1200 through wired or wireless links 1208, such as LPWA links, optical links, and the like. Further, a wired or wireless sub-network 1212 may allow the IoT devices to communicate with each other, such as through a local area network, a wireless local area network, and the like. The IoT devices may use another device, such as a gateway 1310 or 1328 to communicate with remote locations such as the cloud 1300; the IoT devices may also use one or more servers 1330 to facilitate communication with the cloud 1300 or with the gateway 1310. For example, the one or more servers 1330 may operate as an intermediate network node to support a local edge cloud or fog implementation among a local area network. Further, the gateway 1328 that is depicted may operate in a cloud-to-gateway-to-many edge devices configuration, such as with the various IoT devices 1314, 1320, 1324 being constrained or dynamic to an assignment and use of resources in the cloud 1300.

Other example groups of IoT devices may include remote weather stations 1214, local information terminals 1216, alarm systems 1218, automated teller machines 1220, alarm panels 1222, or moving vehicles, such as emergency vehicles 1224 or other vehicles 1226, among many others. Each of these IoT devices may be in communication with other IoT devices, with servers 1204, with another IoT fog device or system (not shown, but depicted in FIG. 11), or a combination therein. The groups of IoT devices may be deployed in various residential, commercial, and industrial settings (including in both private or public environments).

As can be seen from FIG. 12, a large number of IoT devices may be communicating through the cloud 1200. This may allow different IoT devices to request or provide information to other devices autonomously. For example, a group of IoT devices (e.g., the traffic control group 1206) may request a current weather forecast from a group of remote weather stations 1214, which may provide the forecast without human intervention. Further, an emergency vehicle 1224 may be alerted by an automated teller machine 1220 that a burglary is in progress. As the emergency vehicle 1224 proceeds towards the automated teller machine 1220, it may access the traffic control group 1206 to request clearance to the location, for example, by lights turning red to block cross traffic at an intersection in sufficient time for the emergency vehicle 1224 to have unimpeded access to the intersection.

Clusters of IoT devices, such as the remote weather stations 1214 or the traffic control group 1206, may be equipped to communicate with other IoT devices as well as with the cloud 1200. This may allow the IoT devices to form an ad-hoc network between the devices, allowing them to function as a single device, which may be termed a fog device or system (e.g., as described above with reference to FIG. 11).

FIG. 13 is a block diagram of an example of components that may be present in an IoT device 1350 for implementing the techniques described herein. The IoT device 1350 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1350, or as components otherwise incorporated within a chassis of a larger system. Additionally, the block diagram of FIG. 13 is intended to depict a high-level view of components of the IoT device 1350. However, some of the components shown may be omitted, additional components may be present, and different arrangement of the components shown may occur in other implementations.

The IoT device 1350 may include a processor 1352, which may be a microprocessor, a multi-core processor, a multithreaded processor, an ultra-low voltage processor, an embedded processor, or other known processing element. The processor 1352 may be a part of a system on a chip (SoC) in which the processor 1352 and other components are formed into a single integrated circuit, or a single package, such as the Edison™ or Galileo™ SoC boards from Intel. As an example, the processor 1352 may include an Intel® Architecture Core™ based processor, such as a Quark™, an Atom™, an i3, an i5, an i7, or an MCU-class processor, or another such processor available from Intel® Corporation, Santa Clara, California. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1352 may communicate with a system memory 1354 over an interconnect 1356 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 1358 may also couple to the processor 1352 via the interconnect 1356. In an example the storage 1358 may be implemented via a solid state disk drive (SSDD). Other devices that may be used for the storage 1358 include flash memory cards, such as SD cards, microSD cards, xD picture cards, and the like, and USB flash drives. In low power implementations, the storage 1358 may be on-die memory or registers associated with the processor 1352. However, in some examples, the storage 1358 may be implemented using a micro hard disk drive (HDD). Further, any number of new technologies may be used for the storage 1358 in addition to, or instead of, the technologies described, such resistance change memories, phase change memories, holographic memories, or chemical memories, among others.

The components may communicate over the interconnect 1356. The interconnect 1356 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1356 may be a proprietary bus, for example, used in a SoC based system. Other bus systems may be included, such as an I2C interface, an SPI interface, point to point interfaces, and a power bus, among others.

The interconnect 1356 may couple the processor 1352 to a mesh transceiver 1362, for communications with other mesh devices 1364. The mesh transceiver 1362 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1364. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1362 may communicate using multiple standards or radios for communications at different range. For example, the IoT device 1350 may communicate with close devices, e.g., within about 10 meters, using a local transceiver based on BLE, or another low power radio, to save power. More distant mesh devices 1364, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1366 may be included to communicate with devices or services in the cloud 1300 via local or wide area network protocols. The wireless network transceiver 1366 may be a LPWA transceiver that follows the IEEE 802.15.4, or IEEE 802.15.4g standards, among others. The IoT device 1350 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1362 and wireless network transceiver 1366, as described herein. For example, the radio transceivers 1362 and 1366 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1362 and 1366 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1366, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1368 may be included to provide a wired communication to the cloud 1300 or to other devices, such as the mesh devices 1364. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1368 may be included to allow connect to a second network, for example, a NIC 1368 providing communications to the cloud over Ethernet, and a second NIC 1368 providing communications to other devices over another type of network.

The interconnect 1356 may couple the processor 1352 to an external interface 1370 that is used to connect external devices or subsystems. The external devices may include sensors 1372, such as accelerometers, level sensors, flow sensors, optical light sensors, camera sensors, temperature sensors, a global positioning system (GPS) sensors, pressure sensors, barometric pressure sensors, and the like. The external interface 1370 further may be used to connect the IoT device 1350 to actuators 1374, such as power switches, valve actuators, an audible sound generator, a visual warning device, and the like.

In some optional examples, various input/output (I/O) devices may be present within, or connected to, the IoT device 1350. For example, a display or other output device 1384 may be included to show information, such as sensor readings or actuator position. An input device 1386, such as a touch screen or keypad may be included to accept input. An output device 1384 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1350.

A battery 1376 may power the IoT device 1350, although in examples in which the IoT device 1350 is mounted in a fixed location, it may have a power supply coupled to an electrical grid. The battery 1376 may be a lithium ion battery, or a metal-air battery, such as a zinc-air battery, an aluminum-air battery, a lithium-air battery, and the like.

A battery monitor/charger 1378 may be included in the IoT device 1350 to track the state of charge (SoCh) of the battery 1376. The battery monitor/charger 1378 may be used to monitor other parameters of the battery 1376 to provide failure predictions, such as the state of health (SoH) and the state of function (SoF) of the battery 1376. The battery monitor/charger 1378 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1378 may communicate the information on the battery 1376 to the processor 1352 over the interconnect 1356. The battery monitor/charger 1378 may also include an analog-to-digital (ADC) convertor that allows the processor 1352 to directly monitor the voltage of the battery 1376 or the current flow from the battery 1376. The battery parameters may be used to determine actions that the IoT device 1350 may perform, such as transmission frequency, mesh network operation, sensing frequency, and the like.

A power block 1380, or other power supply coupled to a grid, may be coupled with the battery monitor/charger 1378 to charge the battery 1376. In some examples, the power block 1380 may be replaced with a wireless power receiver to obtain the power wirelessly, for example, through a loop antenna in the IoT device 1350. A wireless battery charging circuit, such as an LTC4020 chip from Linear Technologies of Milpitas, California, among others, may be included in the battery monitor/charger 1378. The specific charging circuits chosen depend on the size of the battery 1376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1358 may include instructions 1382 in the form of software, firmware, or hardware commands to implement the techniques described herein. Although such instructions 1382 are shown as code blocks included in the memory 1354 and the storage 1358, it may be understood that any of the code blocks may be replaced with hardwired circuits, for example, built into an application specific integrated circuit (ASIC).

In an example, the instructions 1382 provided via the memory 1354, the storage 1358, or the processor 1352 may be embodied as a non-transitory, machine readable medium 1360 including code to direct the processor 1352 to perform electronic operations in the IoT device 1350. The processor 1352 may access the non-transitory, machine readable medium 1360 over the interconnect 1356. For instance, the non-transitory, machine readable medium 1360 may be embodied by devices described for the storage 1358 of FIG. 13 or may include specific storage units such as optical disks, flash drives, or any number of other hardware devices. The non-transitory, machine readable medium 1360 may include instructions to direct the processor 1352 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

### EXAMPLES

Illustrative examples of the technologies disclosed herein are provided below. An embodiment of the technologies may include any one or more, and any combination of, the examples described below.

Example 1 includes a cloud resource manager for management of accelerator resources, the cloud resource manager comprising a network interface controller to receive accelerator usage information from each of a plurality of node compute devices; and an accelerator manager to receive task parameters of a task to be performed; access a task distribution policy; determine a destination node compute device of the plurality of node compute devices based on the task parameters and the task distribution policy; and assign the task to the destination node compute device.

Example 2 includes the subject matter of Example 1, and wherein the task parameters comprise an indication of an accelerator image to be used in performance of the task, wherein the accelerator usage information comprises an indication that an instance of the accelerator image is available in the destination node compute device, wherein to determine the destination node compute device comprises to determine the destination node compute device based on the indication that the instance of the accelerator image is available in the destination node compute device.

Example 3 includes the subject matter of any of Examples 1 and 2, and wherein the task parameters comprise an indication of an accelerator image to be used in performance of the task, wherein the accelerator usage information comprises an indication that an accelerator device of the destination node compute device has space available for the accelerator image, and wherein to determine the destination node compute device comprises to determine the destination node compute device based on the space available for the accelerator image in the destination node compute device.

Example 4 includes the subject matter of any of Examples 1-3, and wherein the accelerator usage information comprises an indication that the destination node compute device has the hardware capability and capacity for a virtual machine or container associated with the task to be performed, and wherein to determine the destination node compute device comprises to determine the destination node compute device based on the destination node compute device having the hardware capability and capacity for the virtual machine or the container associated with the task to be performed.

Example 5 includes the subject matter of any of Examples 1-4, and wherein the task parameters comprise an indication of an accelerator image to be used in performance of the task, wherein the accelerator usage information comprises an indication that an accelerator device of the destination node compute device would have space available for the accelerator image on an accelerator device after a defragmentation of the accelerator device; wherein to determine the destination node compute device comprises to determine the destination node compute device based on the space available for the accelerator image in the destination node compute device after defragmentation of the accelerator device.

Example 6 includes the subject matter of any of Examples 1-5, and wherein to assign the task to the destination node compute device comprises to send the task parameters to the destination node compute device.

Example 7 includes the subject matter of any of Examples 1-6, and wherein to receive the task parameters comprises to receive the task parameters from a requesting compute device, wherein to assign the task to the destination node compute device comprises to send an identification of the destination node compute device to the requesting compute device.

Example 8 includes the subject matter of any of Examples 1-7, and wherein to receive the accelerator usage information from each of the plurality of node compute devices comprises to receive the accelerator usage information from each of the plurality of node compute devices without a request sent for the accelerator usage information.

Example 9 includes the subject matter of any of Examples 1-8, and wherein the network interface controller is further to send a request to each of the plurality of node compute devices for the corresponding accelerator usage information, wherein to receive the accelerator usage information from each of the plurality of node compute devices comprises to receive the accelerator usage information from each of the plurality of node compute devices in response to the request for the corresponding accelerator usage information.

Example 10 includes the subject matter of any of Examples 1-9, and wherein the task parameters comprise an indication of an accelerator image to be used in performance of the task, wherein the accelerator manager is further to store a plurality of accelerator images, wherein the plurality of accelerator images includes the accelerator image to be used in performance of the task, and wherein the network interface controller is further to send the accelerator image to the destination node compute device in response to receive the indication of the accelerator image to be used in performance of the task.

Example 11 includes the subject matter of any of Examples 1-10, and wherein to store the plurality of accelerator images comprises to store, for each of the plurality of accelerator images, a size, a power usage, and whether the corresponding accelerator image is permitted to be shared.

Example 12 includes the subject matter of any of Examples 1-11, and wherein the accelerator usage information comprises at least one of (i) accelerator images deployed on each of the plurality of node compute devices, (ii) whether each accelerator image deployed on each of the plurality of node compute devices is permitted to be shared, (iii) how much free space is in at least one accelerator device of each of the plurality of node compute devices, (iv) a frequency of use of an accelerator image of at least one accelerator device of each of the plurality of node compute devices, (v) a power usage of each of the plurality of node compute devices, and (vi) an indication of a last time of use of an accelerator image of at least one accelerator device of each of the plurality of node compute devices.

Example 13 includes the subject matter of any of Examples 1-12, and wherein to determine the destination node compute device of the plurality of node compute devices comprises to determine the destination node compute device based on at least one of (i) the accelerator images deployed on each of the plurality of node compute devices, (ii) whether each accelerator image deployed on each of the plurality of node compute devices is permitted to be shared, (iii) how much free space is in the at least one accelerator device of each of the plurality of node compute devices, (iv) the frequency of use of the accelerator image of at least one accelerator device of each of the plurality of node compute devices, (v) the power usage of each of the plurality of node compute devices, and (v) the indication of the last time of use of the accelerator image of at least one accelerator device of each of the plurality of node compute devices.

Example 14 includes a node compute device for management of accelerator resources of the node compute device, the node compute device comprising a network interface controller to receive task parameters of a task to be performed by the node compute device; and an accelerator manager to access a task scheduling policy; schedule the task based on the task parameters and the task scheduling policy; and perform the task on an accelerator device of the node compute device in response to the task being scheduled.

Example 15 includes the subject matter of Example 14, and wherein the network interface controller is further to send accelerator usage information to a cloud resource manager.

Example 16 includes the subject matter of any of Examples 14 and 15, and wherein the accelerator usage information comprises at least one of (i) accelerator images deployed on the node compute devices, (ii) whether each accelerator image deployed on the node compute device is permitted to be shared, (iii) how much free space is in the accelerator device of, (iv) the frequency of use of an accelerator image of the accelerator device, (v) the power usage of the accelerator device, and (vi) an indication of a last time of use of an accelerator image of the accelerator device.

Example 17 includes the subject matter of any of Examples 14-16, and wherein to send the accelerator usage information to the cloud resource manager comprises to send the accelerator usage information to the cloud resource manager without receipt of a request to send the accelerator usage information.

Example 18 includes the subject matter of any of Examples 14-17, and wherein the network interface controller is further to receive a request for the accelerator usage information from a cloud resource manager, wherein to send the accelerator usage information to the cloud resource manager comprises to send the accelerator usage information to the cloud resource manager in response to receipt of the request to send the accelerator usage information.

Example 19 includes the subject matter of any of Examples 14-18, and wherein the task parameters comprise an indication of an accelerator image to be used in performance of the task, wherein the accelerator manager is further to load an instance of the accelerator image on the accelerator device before receipt of the task parameters; and determine, in response to receipt of the task parameters, that the instance of the accelerator image was loaded on the accelerator device before receipt of the task parameters, wherein to schedule the task comprises to schedule the task to run on the instance of the accelerator image in response to a determination that the instance of the accelerator image was loaded on the accelerator device before receipt of the task parameters.

Example 20 includes the subject matter of any of Examples 14-19, and wherein the task parameters comprise an indication of an accelerator image to be used in performance of the task, wherein the accelerator manager is further to determine that there is currently no available space for the accelerator image on the accelerator device; determine that there would be available space for the accelerator image on the accelerator device after defragmentation of the accelerator device; defragment the accelerator device in response to a determination that there would be space available for the accelerator image after defragmentation of the accelerator device; and load the accelerator image on the accelerator device in response to defragmentation of the accelerator device.

Example 21 includes the subject matter of any of Examples 14-20, and wherein the task parameters comprise an indication of an accelerator image to be used in performance of the task, wherein the accelerator manager is further to load an instance of the accelerator image on the accelerator device before receipt of the task parameters; perform at least part of a second task on the accelerator image before receipt of the task parameters; determine, in response to receipt of the task parameters, that the second task should be paged out in favor of the task; and page out the second task from the accelerator device, wherein to page out the second task comprises to save context data of the second task.

Example 22 includes the subject matter of any of Examples 14-21, and wherein the accelerator manager is further to send the context data of the second task to a second node compute device for the second task to be paged in on the second node compute device.

Example 23 includes the subject matter of any of Examples 14-22, and wherein the task parameters comprise an indication of an accelerator image to be used in performance of the task, wherein the accelerator manager is further to perform at least part of a second task on a second accelerator image in the accelerator device before receipt of the task parameters; determine, in response to receipt of the task parameters, that the second task should be paged out in favor of the task; and page out the second task from the accelerator device, wherein to page out the second task comprises to save the second accelerator image to a memory of the node compute device.

Example 24 includes the subject matter of any of Examples 14-23, and wherein to receive the task parameters comprises to receive the task parameters from a requesting compute device, wherein the accelerator manager is further to send a notification of the task launch to the requesting compute device.

Example 25 includes the subject matter of any of Examples 14-24, and wherein to receive the task parameters comprises to receive the task parameters from a requesting compute device, wherein the accelerator manager is further to send a result of the task to the requesting compute device.

Example 26 includes a method for managing accelerator resources by a cloud resource manager, the method comprising receiving, by the cloud resource manager, accelerator usage information from each of a plurality of node compute devices; receiving, by the cloud resource manager, task parameters of a task to be performed; accessing, by the cloud resource manager, a task distribution policy; determining, by the cloud resource manager, a destination node compute device of the plurality of node compute devices based on the task parameters and the task distribution policy; and assigning, by the cloud resource manager, the task to the destination node compute device.

Example 27 includes the subject matter of Example 26, and wherein the task parameters comprise an indication of an accelerator image to be used in performance of the task, wherein the accelerator usage information comprises an indication that an instance of the accelerator image is available in the destination node compute device, wherein determining the destination node compute device comprises determining the destination node compute device based on the indication that the instance of the accelerator image is available in the destination node compute device.

Example 28 includes the subject matter of any of Examples 26 and 27, and wherein the task parameters comprise an indication of an accelerator image to be used in performance of the task, wherein the accelerator usage information comprises an indication that an accelerator device of the destination node compute device has space available for the accelerator image; wherein determining the destination node compute device comprises determining the destination node compute device based on the space available for the accelerator image in the destination node compute device.

Example 29 includes the subject matter of any of Examples 26-28, and wherein the accelerator usage information comprises an indication that the destination node compute device has the hardware capability and capacity for a virtual machine or container associated with the task to be performed, and wherein determining the destination node compute device comprises determining the destination node compute device based on the destination node compute device having the hardware capability and capacity for the virtual machine or the container associated with the task to be performed.

Example 30 includes the subject matter of any of Examples 26-29, and wherein the task parameters comprise an indication of an accelerator image to be used in performance of the task, wherein the accelerator usage information comprises an indication that an accelerator device of the destination node compute device would have space available for the accelerator image on an accelerator device after a defragmentation of the accelerator device; wherein determining the destination node compute device comprises determining the destination node compute device based on the space available for the accelerator image in the destination node compute device after defragmentation of the accelerator device.

Example 31 includes the subject matter of any of Examples 26-30, and wherein assigning the task to the destination node compute device comprises sending the task parameters to the destination node compute device.

Example 32 includes the subject matter of any of Examples 26-31, and wherein receiving the task parameters comprises receiving the task parameters from a requesting compute device, wherein assigning the task to the destination node compute device comprises sending an identification of the destination node compute device to the requesting compute device.

Example 33 includes the subject matter of any of Examples 26-32, and wherein receiving the accelerator usage information from each of the plurality of node compute devices comprises receiving the accelerator usage information from each of the plurality of node compute devices without sending a request for the accelerator usage information.

Example 34 includes the subject matter of any of Examples 26-33, and further including sending a request to each of the plurality of node compute devices for the corresponding accelerator usage information, wherein receiving the accelerator usage information from each of the plurality of node compute devices comprises receiving the accelerator usage information from each of the plurality of node compute devices in response to sending the request for the corresponding accelerator usage information.

Example 35 includes the subject matter of any of Examples 26-34, and wherein the task parameters comprise an indication of an accelerator image to be used in performance of the task, the method further comprising storing, by the cloud resource manager, a plurality of accelerator images, wherein the plurality of accelerator images includes the accelerator image to be used in performance of the task; sending, by the cloud resource manager, the accelerator image to the destination node compute device in response to receiving the indication of the accelerator image to be used in performance of the task.

Example 36 includes the subject matter of any of Examples 26-35, and wherein storing the plurality of accelerator images comprises storing, for each of the plurality of accelerator images, a size, a power usage, and whether the corresponding accelerator image is permitted to be shared.

Example 37 includes the subject matter of any of Examples 26-36, and wherein the accelerator usage information comprises at least one of (i) accelerator images deployed on each of the plurality of node compute devices, (ii) whether each accelerator image deployed on each of the plurality of node compute devices is permitted to be shared, (iii) how much free space is in at least one accelerator device of each of the plurality of node compute devices, (iv) a frequency of use of an accelerator image of at least one accelerator device of each of the plurality of node compute devices, (v) a power usage of each of the plurality of node compute devices, and (vi) an indication of a last time of use of an accelerator image of at least one accelerator device of each of the plurality of node compute devices.

Example 38 includes the subject matter of any of Examples 26-37, and wherein determining the destination node compute device of the plurality of node compute devices comprises determining the destination node compute device based on at least one of (i) the accelerator images deployed on each of the plurality of node compute devices, (ii) whether each accelerator image deployed on each of the plurality of node compute devices is permitted to be shared, (iii) how much free space is in the at least one accelerator device of each of the plurality of node compute devices, (iv) the frequency of use of the accelerator image of at least one accelerator device of each of the plurality of node compute devices, (v) the power usage of each of the plurality of node compute devices, and (vi) the indication of the last time of use of the accelerator image of at least one accelerator device of each of the plurality of node compute devices.

Example 39 includes a method for managing accelerator resources by a node compute device, the method comprising receiving, by the node compute device, task parameters of a task to be performed by the node compute device; accessing, by the node compute device, a task scheduling policy; scheduling, by the node compute device, the task based on the task parameters and the task scheduling policy; and performing, by the node compute device, the task on an accelerator device of the node compute device in response to scheduling the task.

Example 40 includes the subject matter of Example 39, and further including sending accelerator usage information to a cloud resource manager.

Example 41 includes the subject matter of any of Examples 39 and 40, and wherein the accelerator usage information comprises at least one of (i) accelerator images deployed on the node compute devices, (ii) whether each accelerator image deployed on the node compute device is permitted to be shared, (iii) how much free space is in the accelerator device of, (iv) the frequency of use of an accelerator image of the accelerator device, (v) the power usage of the accelerator device, and (v) an indication of a last time of use of an accelerator image of the accelerator device.

Example 42 includes the subject matter of any of Examples 39-41, and wherein sending the accelerator usage information to the cloud resource manager comprises sending the accelerator usage information to the cloud resource manager without receiving a request to send the accelerator usage information.

Example 43 includes the subject matter of any of Examples 39-42, and further including receiving a request for the accelerator usage information from a cloud resource manager, wherein sending the accelerator usage information to the cloud resource manager comprises sending the accelerator usage information to the cloud resource manager in response to receipt of the request to send the accelerator usage information.

Example 44 includes the subject matter of any of Examples 39-43, and wherein the task parameters comprise an indication of an accelerator image to be used in performance of the task, the method further comprising loading, by the node compute device, an instance of the accelerator image on the accelerator device before receipt of the task parameters; and determining, by the node compute device and in response to receipt of the task parameters, that the instance of the accelerator image was loaded on the accelerator device before receipt of the task parameters, wherein scheduling the task comprises scheduling the task to run on the instance of the accelerator image in response to a determination that the instance of the accelerator image was loaded on the accelerator device before receipt of the task parameters.

Example 45 includes the subject matter of any of Examples 39-44, and wherein the task parameters comprise an indication of an accelerator image to be used in performance of the task, the method further comprising determining, by the node compute device, that there is currently no available space for the accelerator image on the accelerator device; determining, by the node compute device, that there would be available space for the accelerator image on the accelerator device after defragmentation of the accelerator device; defragmenting, by the node compute device, the accelerator device in response to a determination that there would be space available for the accelerator image after defragmentation of the accelerator device; and loading, by the node compute device, the accelerator image on the accelerator device in response to defragmentation of the accelerator device.

Example 46 includes the subject matter of any of Examples 39-45, and wherein the task parameters comprise an indication of an accelerator image to be used in performance of the task, the method further comprising loading, by the node compute device, an instance of the accelerator image on the accelerator device before receipt of the task parameters; performing, by the node compute device, at least part of a second task on the accelerator image before receipt of the task parameters; determining, by the node compute device and in response to receipt of the task parameters, that the second task should be paged out in favor of the task; and paging out, by the node compute device, the second task from the accelerator device, wherein paging out the second task comprises saving context data of the second task.

Example 47 includes the subject matter of any of Examples 39-46, and further including sending the context data of the second task to a second node compute device for the second task to be paged in on the second node compute device.

Example 48 includes the subject matter of any of Examples 39-47, and wherein the task parameters comprise an indication of an accelerator image to be used in performance of the task, the method further comprising performing, by the node compute device, at least part of a second task on a second accelerator image in the accelerator device before receipt of the task parameters; determining, by the node compute device and in response to receipt of the task parameters, that the second task should be paged out in favor of the task; and paging out, by the node compute device, the second task from the accelerator device, wherein paging out the second task comprises saving the second accelerator image to a memory of the node compute device.

Example 49 includes the subject matter of any of Examples 39-48, and wherein receiving the task parameters comprises receiving the task parameters from a requesting compute device, the method further comprising sending, by the node compute device, a notification of the task launch to the requesting compute device.

Example 50 includes the subject matter of any of Examples 39-49, and wherein receiving the task parameters comprises receiving the task parameters from a requesting compute device, the method further comprising sending, by the node compute device, a result of the task to the requesting compute device.

Example 51 includes one or more computer-readable media comprising a plurality of instructions stored thereon that, when executed, causes a node compute device to perform the method of any of Examples 26-49.

Example 52 includes a cloud resource manager for management of accelerator resources, the cloud resource manager comprising means for receiving accelerator usage information from each of a plurality of node compute devices; means for receiving task parameters of a task to be performed; means for accessing a task distribution policy; means for determining a destination node compute device of the plurality of node compute devices based on the task parameters and the task distribution policy; and means for assigning the task to the destination node compute device.

Example 53 includes the subject matter of Example 52, and wherein the task parameters comprise an indication of an accelerator image to be used in performance of the task, wherein the accelerator usage information comprises an indication that an instance of the accelerator image is available in the destination node compute device, wherein the means for determining the destination node compute device comprises means for determining the destination node compute device based on the indication that the instance of the accelerator image is available in the destination node compute device.

Example 54 includes the subject matter of any of Examples 52 and 53, and wherein the task parameters comprise an indication of an accelerator image to be used in performance of the task, wherein the accelerator usage information comprises an indication that an accelerator device of the destination node compute device has space available for the accelerator image; wherein the means for determining the destination node compute device comprises means for determining the destination node compute device based on the space available for the accelerator image in the destination node compute device.

Example 55 includes the subject matter of any of Examples 52-54, and wherein the accelerator usage information comprises an indication that the destination node compute device has the hardware capability and capacity for a virtual machine or container associated with the task to be performed, and wherein the means for determining the destination node compute device comprises means for determining the destination node compute device based on the destination node compute device having the hardware capability and capacity for the virtual machine or the container associated with the task to be performed.

Example 56 includes the subject matter of any of Examples 52-55, and wherein the task parameters comprise an indication of an accelerator image to be used in performance of the task, wherein the accelerator usage information comprises an indication that an accelerator device of the destination node compute device would have space available for the accelerator image on an accelerator device after a defragmentation of the accelerator device; wherein the means for determining the destination node compute device comprises means for determining the destination node compute device based on the space available for the accelerator image in the destination node compute device after defragmentation of the accelerator device.

Example 57 includes the subject matter of any of Examples 52-56, and wherein the means for assigning the task to the destination node compute device comprises means for sending the task parameters to the destination node compute device.

Example 58 includes the subject matter of any of Examples 52-57, and wherein the means for receiving the task parameters comprises means for receiving the task parameters from a requesting compute device, wherein the means for assigning the task to the destination node compute device comprises means for sending an identification of the destination node compute device to the requesting compute device.

Example 59 includes the subject matter of any of Examples 52-58, and wherein the means for receiving the accelerator usage information from each of the plurality of node compute devices comprises means for receiving the accelerator usage information from each of the plurality of node compute devices without sending a request for the accelerator usage information.

Example 60 includes the subject matter of any of Examples 52-59, and further including means for sending a request to each of the plurality of node compute devices for the corresponding accelerator usage information, wherein the means for receiving the accelerator usage information from each of the plurality of node compute devices comprises means for receiving the accelerator usage information from each of the plurality of node compute devices in response to sending the request for the corresponding accelerator usage information.

Example 61 includes the subject matter of any of Examples 52-60, and wherein the task parameters comprise an indication of an accelerator image to be used in performance of the task, the method further comprising means for storing a plurality of accelerator images, wherein the plurality of accelerator images includes the accelerator image to be u sed in performance of the task; means for sending the accelerator image to the destination node compute device in response to receiving the indication of the accelerator image to be used in performance of the task.

Example 62 includes the subject matter of any of Examples 52-61, and wherein the means for storing the plurality of accelerator images comprises means for storing, for each of the plurality of accelerator images, a size, a power usage, and whether the corresponding accelerator image is permitted to be shared.

Example 63 includes the subject matter of any of Examples 52-62, and wherein the accelerator usage information comprises at least one of (i) accelerator images deployed on each of the plurality of node compute devices, (ii) whether each accelerator image deployed on each of the plurality of node compute devices is permitted to be shared, (iii) how much free space is in at least one accelerator device of each of the plurality of node compute devices, (iv) a frequency of use of an accelerator image of at least one accelerator device of each of the plurality of node compute devices, (v) a power usage of each of the plurality of node compute devices, and (vi) an indication of a last time of use of an accelerator image of at least one accelerator device of each of the plurality of node compute devices.

Example 64 includes the subject matter of any of Examples 52-63, and wherein the means for determining the destination node compute device of the plurality of node compute devices comprises means for determining the destination node compute device based on at least one of (i) the accelerator images deployed on each of the plurality of node compute devices, (ii) whether each accelerator image deployed on each of the plurality of node compute devices is permitted to be shared, (iii) how much free space is in the at least one accelerator device of each of the plurality of node compute devices, (iv) the frequency of use of the accelerator image of at least one accelerator device of each of the plurality of node compute devices, (v) the power usage of each of the plurality of node compute devices, and (vi) the indication of the last time of use of the accelerator image of at least one accelerator device of each of the plurality of node compute devices.

Example 65 includes a node compute device for management of accelerator resources of the node compute device, the node compute device comprising means for receiving, by the node compute device, task parameters of a task to be performed by the node compute device; means for accessing, by the node compute device, a task scheduling policy; means for scheduling, by the node compute device, the task based on the task parameters and the task scheduling policy; and means for performing, by the node compute device, the task on an accelerator device of the node compute device in response to scheduling the task.

Example 66 includes the subject matter of Example 65, and further including means for sending accelerator usage information to a cloud resource manager.

Example 67 includes the subject matter of any of Examples 65 and 66, and wherein the accelerator usage information comprises at least one of (i) accelerator images deployed on the node compute devices, (ii) whether each accelerator image deployed on the node compute device is permitted to be shared, (iii) how much free space is in the accelerator device of, (iv) the frequency of use of an accelerator image of the accelerator device, (v) the power usage of the accelerator device, and (v) an indication of a last time of use of an accelerator image of the accelerator device.

Example 68 includes the subject matter of any of Examples 65-67, and wherein the means for sending the accelerator usage information to the cloud resource manager comprises means for sending the accelerator usage information to the cloud resource manager without receiving a request to send the accelerator usage information.

Example 69 includes the subject matter of any of Examples 65-68, and further including means for receiving a request for the accelerator usage information from a cloud resource manager, wherein the means for sending the accelerator usage information to the cloud resource manager comprises means for sending the accelerator usage information to the cloud resource manager in response to receipt of the request to send the accelerator usage information.

Example 70 includes the subject matter of any of Examples 65-69, and wherein the task parameters comprise an indication of an accelerator image to be used in performance of the task, the method further comprising means for loading, by the node compute device, an instance of the accelerator image on the accelerator device before receipt of the task parameters; and means for determining, by the node compute device and in response to receipt of the task parameters, that the instance of the accelerator image was loaded on the accelerator device before receipt of the task parameters, wherein the means for scheduling the task comprises means for scheduling the task to run on the instance of the accelerator image in response to a determination that the instance of the accelerator image was loaded on the accelerator device before receipt of the task parameters.

Example 71 includes the subject matter of any of Examples 65-70, and wherein the task parameters comprise an indication of an accelerator image to be used in performance of the task, the method further comprising means for determining, by the node compute device, that there is currently no available space for the accelerator image on the accelerator device; means for determining, by the node compute device, that there would be available space for the accelerator image on the accelerator device after defragmentation of the accelerator device; means for defragmenting, by the node compute device, the accelerator device in response to a determination that there would be space available for the accelerator image after defragmentation of the accelerator device; and means for loading, by the node compute device, the accelerator image on the accelerator device in response to defragmentation of the accelerator device.

Example 72 includes the subject matter of any of Examples 65-71, and wherein the task parameters comprise an indication of an accelerator image to be used in performance of the task, the method further comprising means for loading, by the node compute device, an instance of the accelerator image on the accelerator device before receipt of the task parameters; means for performing, by the node compute device, at least part of a second task on the accelerator image before receipt of the task parameters; means for determining, by the node compute device and in response to receipt of the task parameters, that the second task should be paged out in favor of the task; and means for paging out, by the node compute device, the second task from the accelerator device, wherein the means for paging out the second task comprises means for saving context data of the second task.

Example 73 includes the subject matter of any of Examples 65-72, and further including means for sending the context data of the second task to a second node compute device for the second task to be paged in on the second node compute device.

Example 74 includes the subject matter of any of Examples 65-73, and wherein the task parameters comprise an indication of an accelerator image to be used in performance of the task, the method further comprising means for performing, by the node compute device, at least part of a second task on a second accelerator image in the accelerator device before receipt of the task parameters; means for determining, by the node compute device and in response to receipt of the task parameters, that the second task should be paged out in favor of the task; and means for paging out, by the node compute device, the second task from the accelerator device, wherein the means for paging out the second task comprises means for saving the second accelerator image to a memory of the node compute device.

Example 75 includes the subject matter of any of Examples 65-74, and wherein the means for receiving the task parameters comprises means for receiving the task parameters from a requesting compute device, the method further comprising means for sending, by the node compute device, a notification of the task launch to the requesting compute device.

Example 76 includes the subject matter of any of Examples 65-75, and wherein the means for receiving the task parameters comprises means for receiving the task parameters from a requesting compute device, the method further comprising means for sending, by the node compute device, a result of the task to the requesting compute device.

1. A cloud resource manager for management of FPGA resources, the cloud resource manager comprising:
network interface circuitry to obtain task parameters of a first requested task and field programmable gate array (FPGA) usage information, the task parameters to indicate an accelerator image to be used in performance of the first requested task;
computer readable instructions; and
processor circuitry to execute the computer readable instructions to:
assign the first requested task to a destination FPGA based on the task parameters and a task distribution policy;
cause reimaging of the destination FPGA and configuration of the destination FPGA per the accelerator image;
cause transmission of an identification of the destination FPGA to a requesting device, the requesting device to communicate with the destination FPGA to cause the destination FPGA to perform the first requested task; and
assign a second requested task to the destination FPGA based on the FPGA usage information, and a priority of the second requested task.

2. The cloud resource manager of claim 1, wherein the task parameters include an indication of the accelerator image to be used in performance of the second requested task;
wherein the FPGA usage information includes an indication that an instance of the accelerator image is available in the destination FPGA; and
wherein to determine the destination FPGA includes to determine the destination FPGA based on the indication that the instance of the accelerator image is available in the destination FPGA.

3. The cloud resource manager of claim 1, wherein the task parameters include an indication of an accelerator image to be used in performance of the second requested task;
wherein the FPGA usage information includes an indication that the destination FPGA has space available for the accelerator image; and
wherein to determine the destination FPGA includes to determine the destination FPGA based on the space available for the accelerator image in the FPGA.

4. The cloud resource manager of the claim 1, wherein the task parameters include an indication of an accelerator image to be used in performance of the second requested task;
wherein the FPGA usage information includes an indication that the destination FPGA would have space available for the accelerator image after a defragmentation of the destination FPGA; and
wherein to determine the destination FPGA includes to determine the destination FPGA based on the space available for the accelerator image in the destination FPGA after defragmentation of the FPGA.

5. The cloud resource manager of claim 1, wherein the task parameters include an indication of an accelerator image to be used in performance of the second requested task, wherein the processor circuitry is further to store a plurality of accelerator images, wherein the plurality of accelerator images includes the accelerator image to be used in performance of the second requested task; and
wherein the network interface circuitry is further to send the accelerator image to the destination FPGA in response to receive the indication of the accelerator image to be used in performance of the second requested task.

6. The cloud resource manager of claim 1, wherein the FPGA usage information includes at least one of (i) accelerator images deployed on each of a plurality of FPGAs, (ii) whether each accelerator image deployed on each of the plurality of FPGAs is permitted to be shared, (iii) how much free space is in each of the plurality of FPGAs, (iv) a frequency of use of an accelerator image of each of the FPGAs, (v) a power usage of each of the plurality of FPGAs, and (vi) an indication of a last time of use of an accelerator image of at least one of the plurality of FPGAs.

7. The cloud resource manager of claim 1, wherein to determine the destination FPGA of a plurality of FPGAs includes to determine the destination FPGA based on at least one of (i) the accelerator images deployed on each of the plurality of FPGAs, (ii) whether each accelerator image deployed on each of the plurality of FPGAs is permitted to be shared, (iii) how much free space is in the at least one of the plurality of FPGAs, (iv) a frequency of use of the accelerator image of at least one of the plurality of FPGAs, (v) a power usage of each of the plurality of FPGAs, and (vi) the indication of the last time of use of the accelerator image of at least one of the plurality of FPGAs.

8. A non-transitory computer readable medium comprising instruction which, when executed, cause at least one processor to at least:
assign the first requested task to a destination FPGA based on the task parameters and a task distribution policy;
cause reimaging of the destination FPGA and configuration of the destination FPGA per the accelerator image;
cause transmission of an identification of the destination FPGA to a requesting device, the requesting device to communicate with the destination FPGA to cause the destination FPGA to perform the first requested task; and
assign a second requested task to the destination FPGA based on the FPGA usage information, and a priority of the second requested task.

9. The non-transitory computer readable medium of claim 8, wherein the task parameters include an indication of the accelerator image to be used in performance of the second requested task;
wherein the FPGA usage information includes an indication that an instance of the accelerator image is available in the destination FPGA; and
wherein to determine the destination FPGA includes to determine the destination FPGA based on the indication that the instance of the accelerator image is available in the destination FPGA.

10. The non-transitory computer readable medium of claim 8, wherein the task parameters include an indication of an accelerator image to be used in performance of the second requested task;
wherein the FPGA usage information includes an indication that the destination FPGA has space available for the accelerator image; and
wherein to determine the destination FPGA includes to determine the destination FPGA based on the space available for the accelerator image in the FPGA.

11. The non-transitory computer readable medium of the claim 8, wherein the task parameters include an indication of an accelerator image to be used in performance of the second requested task;
wherein the FPGA usage information includes an indication that the destination FPGA would have space available for the accelerator image after a defragmentation of the destination FPGA; and
wherein to determine the destination FPGA includes to determine the destination FPGA based on the space available for the accelerator image in the destination FPGA after defragmentation of the FPGA.

12. The non-transitory computer readable medium of claim 8, wherein the task parameters include an indication of an accelerator image to be used in performance of the second requested task, wherein the processor circuitry is further to store a plurality of accelerator images, wherein the plurality of accelerator images includes the accelerator image to be used in performance of the second requested task; and
wherein a network interface circuitry is further to send the accelerator image to the destination FPGA in response to receive the indication of the accelerator image to be used in performance of the second requested task.

13. The non-transitory computer readable medium of claim 8, wherein the FPGA usage information includes at least one of (i) accelerator images deployed on each of a plurality of FPGAs, (ii) whether each accelerator image deployed on each of the plurality of FPGAs is permitted to be shared, (iii) how much free space is in each of the plurality of FPGAs, (iv) a frequency of use of an accelerator image of each of the FPGAs, (v) a power usage of each of the plurality of FPGAs, and (vi) an indication of a last time of use of an accelerator image of at least one of the plurality of FPGAs.

14. The non-transitory computer readable medium of claim 8, wherein to determine the destination FPGA of a plurality of FPGAs includes to determine the destination FPGA based on at least one of (i) the accelerator images deployed on each of the plurality of FPGAs, (ii) whether each accelerator image deployed on each of the plurality of FPGAs is permitted to be shared, (iii) how much free space is in the at least one of the plurality of FPGAs, (iv) a frequency of use of the accelerator image of at least one of the plurality of FPGAs, (v) a power usage of each of the plurality of FPGAs, and (vi) the indication of the last time of use of the accelerator image of at least one of the plurality of FPGAs.

15. A method, comprising:
assigning, by executing an instruction with processor circuitry, the first requested task to a destination FPGA based on the task parameters and a task distribution policy;
causing, by executing an instruction with the processor circuitry, reimaging of the destination FPGA and configuration of the destination FPGA per the accelerator image;
causing, by executing an instruction with the processor circuitry, transmission of an identification of the destination FPGA to a requesting device, the requesting device to communicate with the destination FPGA to cause the destination FPGA to perform the first requested task; and
assigning, by executing an instruction with the processor circuitry, a second requested task to the destination FPGA based on the FPGA usage information, and a priority of the second requested task.

16. The method of claim 15, wherein the task parameters include an indication of the accelerator image to be used in performance of the second requested task;
wherein the FPGA usage information includes an indication that an instance of the accelerator image is available in the destination FPGA; and
wherein determining the destination FPGA includes determining the destination FPGA based on the indication that the instance of the accelerator image is available in the destination FPGA.

17. The method of claim 15, wherein the task parameters include an indication of an accelerator image to be used in performance of the second requested task;
wherein the FPGA usage information includes an indication that the destination FPGA has space available for the accelerator image; and
wherein determining the destination FPGA includes determining the destination FPGA based on the space available for the accelerator image in the FPGA.

18. The method of claim 15, wherein the task parameters include an indication of an accelerator image to be used in performance of the second requested task;
wherein the FPGA usage information includes an indication that the destination FPGA would have space available for the accelerator image after a defragmentation of the destination FPGA; and
wherein determining the destination FPGA includes determining the destination FPGA based on the space available for the accelerator image in the destination FPGA after defragmenting the FPGA.

19. The method of claim 15, wherein the task parameters include an indication of an accelerator image to be used in performance of the second requested task, wherein the processor circuitry further includes storing a plurality of accelerator images, wherein the plurality of accelerator images includes the accelerator image to be used in performance of the second requested task; and
wherein a network interface circuitry further includes sending the accelerator image to the destination FPGA in response to receiving the indication of the accelerator image to be used in performance of the second requested task.

20. The method of claim 15, wherein the FPGA usage information includes at least one of (i) accelerator images deployed on each of a plurality of FPGAs, (ii) whether each accelerator image deployed on each of the plurality of FPGAs is permitted to be shared, (iii) how much free space is in each of the plurality of FPGAs, (iv) a frequency of use of an accelerator image of each of the FPGAs, (v) a power usage of each of the plurality of FPGAs, and (vi) an indication of a last time of use of an accelerator image of at least one of the plurality of FPGAs.
